(19) United States
(12) Patent Application Publication
(10) Pub. No.: US 2012/0321541 A1
(43) Pub. Date: Dec. 20, 2012

(54) Methods for Refining Aluminum-Containing Silicon

(75) Inventors: Vishu Dutt Dosaj, Midland, MI (US); Reinaldo Rodrigues Bittar, Santos Dumont (BR)

(73) Assignee: Dow Corning Corporation, Midland, MI (US)

(21) Appl. No.: 13/581,977

(22) PCT Filed: Feb. 28, 2011
(86) PCT No.: PCT/US11/26483

§ 371 Date: Aug. 30, 2012

Related U.S. Application Data
(60) Provisional application No. 61/309,132, filed on Mar. 1, 2010.

(51) Int. Cl. C01B 33/037

(52) U.S. Cl. 423/348

(57) ABSTRACT

A method for refining aluminum-containing silicon is provided and includes heating an aluminum-containing silicon to form a molten aluminum-containing silicon, adding a source of calcium selected from the group consisting of calcium, calcium oxide, and calcium carbonate, and, optionally silica to the aluminum-containing silicon; and exposing the molten aluminum-containing silicon to oxygen to produce a refined silicon and a by-product slag such that the refined silicon contains an amount of aluminum less than the amount of aluminum in the aluminum-containing silicon.

### FIELD OF THE INVENTION

This disclosure relates to silicon purification, and more particularly to purifying such silicon by refining aluminum-containing silicon to produce silicon having greater purity.

### BACKGROUND OF THE INVENTION

Silicon for solar applications can be produced by first alloying metallurgical grade silicon with molten aluminum to produce a silicon-aluminum alloy initially comprising about 25-80 wt. % silicon, 20-75 wt. % aluminum, and other impurities such as calcium and boron. The silicon-aluminum alloy may then undergo crystallization to produce silicon flakes that comprise approximately 90 wt % silicon and 10 wt % aluminum. Acid treatment may then be used to remove additional aluminum from the silicon flakes to produce a purified silicon containing from about 1000-3000 parts per million by weight (ppmw) aluminum. However, it may be desirable to remove even more aluminum from such silicon to achieve purity levels where such silicon can be crystallized to produce silicon that is suitable for solar grade applications. Typically, a silicon purity of 6N (i.e., 99.9999 mass %) is desirable for solar applications.

One option for the further removal of aluminum from the aluminum-containing silicon is directional solidification. However, such a process requires costly repetition and may not always be commercially viable. Additionally, where the silicon contains trace amounts of other impurities such as calcium, the amount of aluminum that can be removed during refining may be limited because the ratio of calcium to aluminum in the silicon affects further aluminum removal. Thus, there remains a need to provide for the further purification of the silicon to remove additional amounts of aluminum, even where only small amounts of those impurities remain, so that the silicon can be used in solar grade applications.

### SUMMARY

In one embodiment, a method for refining aluminum-containing silicon includes adding a calcium source selected from the group consisting of Ca, CaO, and CaCO₃, and optionally with SiO₂ to an aluminum-containing silicon. The aluminum-containing silicon is heated to melt it, and the molten aluminum-containing silicon is exposed to oxygen to produce a refined silicon and a by-product slag such that the refined silicon contains an amount of aluminum less than the amount of aluminum in the aluminum-containing silicon. The source of calcium, and optionally silica, may be combined with the aluminum-containing silicon either prior to, during, or after heating takes place. However, preferably the aluminum-containing silicon is melted prior to the addition of the source of calcium and optionally silica.

### BRIEF DESCRIPTION OF THE DRAWINGS

The embodiments set forth in the drawings are illustrative and exemplary in nature and not intended to limit the invention the scope of which is defined by the appended claims. The following detailed description of the illustrative embodiments can be understood when read in conjunction with the following drawing, where like structure is indicated with like reference numerals and in which:

FIG. 1 depicts a flowchart of an exemplary method for refining aluminum-containing silicon according to one or more embodiments shown and described herein.

### DETAILED DESCRIPTION

Embodiments of the present disclosure provide methods for refining aluminum-containing silicon to produce refined silicon having a purity that may be used for applications including, but not limited to, solar applications. Specifically, embodiments of the present disclosure provide methods for removing aluminum from aluminum-containing silicon, even where the silicon contains only trace amounts of other impurities, through the addition of a source of calcium in the form of calcium, calcium oxide, or calcium carbonate and oxygen. Optionally, silica may also be added. As used herein, the phrase “aluminum-containing silicon” refers to any silicon product that comprises an initial amount of aluminum that is from about 1,000 up to about 12,000 parts per million by weight (ppmw), such as up to 10,000 ppmw of aluminum, or from 1,000 ppmw to 3,000 ppmw of aluminum, and only trace amounts of other impurities such as, for example, As, B, Ca, Cr, Co, Cu, Fe, Pb, Mg, Mn, Mo, Ni, P, K, Na, Ti, V, Zn, and Zr. As used herein, “trace amounts” means less than about 30 ppmw of any one impurity, as measured by methods known in the art such as by x-ray fluorescence or ICP-MS (inductively coupled mass spectrometry). The terms “molten silicon” and “molten aluminum-containing silicon” are used interchangeably herein and refer to the aluminum-containing silicon material after melting. The term “refined silicon” as used herein refers to the silicon after treatment and having an aluminum content that is less than the amount of aluminum in the original aluminum-containing silicon.

By adding a source of calcium, or a mixture of the calcium source and silica, with oxygen to the aluminum-containing silicon, a separable by-product slag is produced which contains at least a portion of the initial aluminum impurity. As used herein, the term “by-product slag” refers to a by-product containing impurities that is separated from the molten aluminum-containing silicon during refining as is explained in greater detail below. The method results in the production of refined silicon having an amount of aluminum that is less than the amount of aluminum in the original aluminum-containing silicon, with only trace amounts of other impurities. Surprisingly, the addition of calcium to the aluminum-containing silicon during refining does not result in an appreciable increase in the amount of calcium in the refined silicon product. Only trace amounts of calcium appear in the refined silicon product. Further, the refining process results in the reduction in boron (B) content of the refined silicon product by up to about 12 wt %, typically about 5-12 wt %. Generally, the amount of aluminum contained in the refined silicon comprises from about 10 to about 100 ppmw, and is preferably less than about 50 ppmw aluminum.

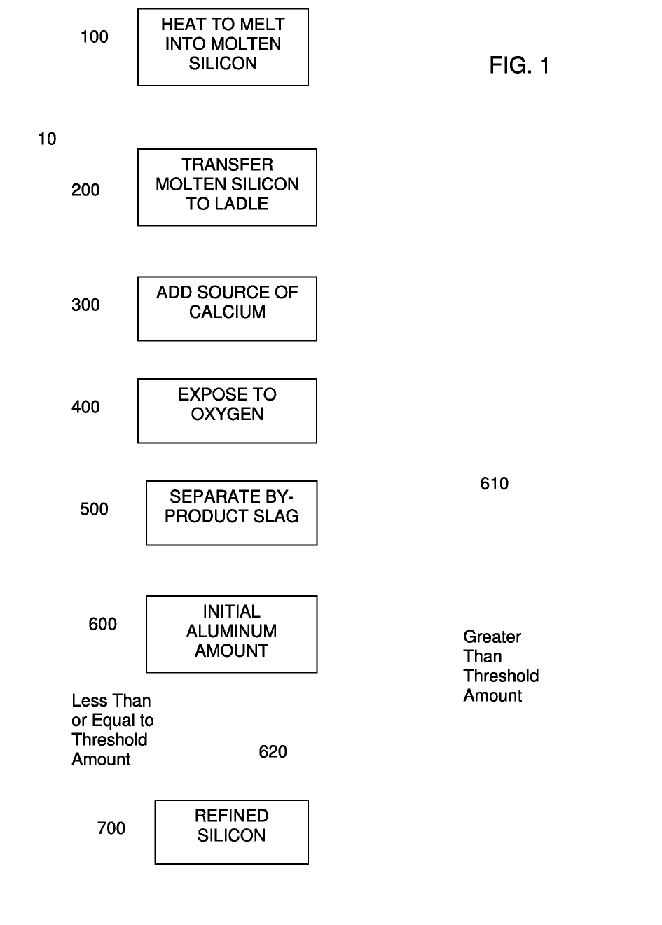

Referring to FIG. 1, an exemplary refining method 10 provides for the refining of aluminum-containing silicon into refined silicon. The refining method 10 generally comprises obtaining molten aluminum-containing silicon such as by melting an acid-treated silicon aluminum alloy. The aluminum-containing silicon can be produced or provided for through a variety of processes or methods known in the art. For example, silicon and aluminum may be alloyed, crystallized and acid treated as discussed above, produced from any other method as appreciated by those skilled in the art, or alternatively purchased from commercial sources. In one specific embodiment, the aluminum-containing silicon comprises silicon flakes comprising an initial amount of aluminum of up to 12,000 ppmw and only trace amounts of other impurities. In an alternative embodiment, aluminum-containing silicon can comprise other forms such as, but not limited to, ingots, shots or chips so long as the initial amount of aluminum in the silicon is less than or equal to 12,000 ppmw and the silicon contains only trace amounts of other impurities. The initial amount of aluminum in the silicon will influence the overall refining method 10, such as, for example, whether the refining method 10 is repeated and performed multiple times to reduce the amount of aluminum in the refined silicon.

In one embodiment, the aluminum-containing silicon may be provided to the induction furnace directly. The aluminum-containing silicon is then heated to form molten silicon in step 100. During step 100, the silicon may be heated to any temperature sufficient to reduce the silicon to a molten state. For example, in one embodiment, the silicon may be heated to a temperature of 1400° C. to 1700° C., or from 1500° C. to 1600° C., or to approximately 1550° C. As appreciated by those skilled in the art, heating temperatures may vary throughout step 100. Thus, where it is said that aluminum-containing silicon is heated to a temperature of about 1550° C., it should be appreciated that the actual temperature may fluctuate and may not be held constant at said temperature. Furthermore, the temperature at which the aluminum-containing silicon is heated to may depend on the temperatures desired during later steps in refining method 10. For example, where in subsequent steps of refining method 10, it may be preferred to utilize a lower temperature (for example, a temperature less that about 1500° C.) as opposed to a higher temperature, the temperature that the aluminum-containing silicon is heated to in step 100 may take into account predicted heat losses for subsequent steps. Thus, the actual temperature used for melting the aluminum-containing silicon into molten silicon may depend, in part, on both anticipated heat loss as well as the desired temperature for subsequent steps of the overall refining method 10.

The heating and melting of the aluminum-containing silicon in step 100 may be accomplished in a variety of ways. For example, in one embodiment, the silicon may be melted using an induction furnace, a resistance furnace, or any other technique used in the art to heat and melt silicon. In some embodiments, it may be desirable to employ an induction furnace with a cycle frequency less than 3000 to allow for vigorous stiffing so that substantially all of the silicon is dispersed as it is melted. In another embodiment, the aluminum-containing silicon may be heated in a gas-fired furnace. In yet another embodiment, the aluminum-containing silicon may be heated in an electrical furnace. Any other heating apparatus operable to melt the aluminum-containing silicon may alternatively be used such that the silicon is melted.

After the aluminum-containing silicon is heated to a molten state in step 100, the molten silicon is exposed to oxygen. For example, in one embodiment, the molten aluminum-containing silicon is transferred to a ladle in step 200. The ladle may comprise any metallurgical ladle operable to reduce heat loss from the molten silicon and permit the injection of oxygen into the molten material. In one embodiment, the ladle may comprise a porous plug or a lance from the top of the refining ladle operable to facilitate the injection of oxygen into the molten silicon while the molten silicon is disposed in the ladle. In another embodiment, a cover may be placed over the ladle to further reduce heat loss from the molten silicon. In yet another embodiment, the molten silicon may be transferred into any other container, receptacle or other storage device capable of allowing the injection of a gas or mixture of gases into the molten silicon.

Once the molten aluminum-containing silicon is transferred to the ladle in step 200, a source of calcium is added to the molten aluminum-containing silicon in step 300. Optionally, a source of silica (SiO₂) may also be added. Alternatively, a source of calcium, and optionally a source of silica, may be placed in the bottom of the refining ladle before transferring the molten into the ladle.

Without intending to be bound by any one particular theory, it is believed that the addition of a source of calcium, or optionally a mixture of a source of calcium and silica, results in the removal of aluminum via the production of a by-product slag once the molten material is exposed to oxygen such as, for example, by injecting oxygen into the molten material. That is, by adding appropriate amounts of the calcium source to the molten silicon and heating the molten silicon to a desired temperature, all as described herein, the calcium is believed to distribute itself as a dissolved element in the molten silicon and as an oxide in the by-product slag. The source of calcium can be produced by means readily available to those skilled in the art or purchased commercially. The amount of calcium to be added to the molten aluminum-containing silicon depends on the initial amount of aluminum in the silicon and the total weight of silicon being refined.

By knowing 1) the initial amount of aluminum in the molten silicon, and 2) the targeted amount of aluminum in the byproduct slag, one may derive, using thermodynamic principles, the proper amount of calcium to be added to the molten silicon to effect a desired reduction in the amount of aluminum in the molten silicon. For example, to achieve an aluminum content in the refined silicon product of less than about 50 ppmw, the initial silicon-containing aluminum may be heated to about 1550° C. and, depending on the initial aluminum content, an appropriate amount of calcium is added.

If the source of calcium is added as calcium oxide or calcium carbonate, the weight added should be proportionately calculated to achieve the proper weight based on calcium. Optionally, silica (SiO₂) may be added to the aluminum-containing silicon to aid in aluminum reduction in the refined product. Generally, for aluminum concentrations of from about 0.05 to about 0.3 wt. % in the aluminum-containing silicon material, calcium may be added in amounts ranging from about 0.05 to about 3.0 wt. % calcium, based on the total weight of the aluminum-containing silicon material. The ratio of the weight % of calcium added to the weight % of aluminum present in the aluminum-containing silicon material is from about 1 to about 10, from about 2 to about 7, from about 3 to about 6.5, and from about 4.5 to about 5.5.

Again, the addition of silica is dependent upon the amount of aluminum present in the initial aluminum-containing silicon material. For aluminum concentrations of from about 0.05 to about 0.3 wt. % in the aluminum-containing silicon material, silica may be added in amounts ranging from about 1.0 to about 10.0 wt. % silica, based on the total weight of the aluminum-containing silicon material. Typically, the ratio of wt. % silica to wt. % aluminum will range from about 0 to about 50, from about 20 to about 40, from about 25 to about 30, and from about 26 to about 28.

In one embodiment, the source of calcium may be added in the form of precipitated calcium carbonate (CaCO₃). In such an embodiment, calcium carbonate is added to the molten silicon as a weight percent of the molten silicon. The added calcium carbonate can range from greater than 0.1 wt % to 10 wt %, from 1 wt % to 5 wt %, or to about 2.5 wt % of the weight of the molten silicon. As discussed above, the amount of calcium carbonate added to the molten silicon may depend on the initial level of aluminum in the silicon, the targeted amount of aluminum in the by-product slag, as well as the desired amount of aluminum and calcium in the refined silicon. The calcium carbonate may be introduced into the molten silicon by injecting powdered calcium carbonate, or, optionally, a mixture of calcium carbonate and silica through a lance with oxygen, nitrogen, or a mixture of nitrogen and oxygen. The optional addition of silica (SiO₂) with the calcium carbonate operates to provide a desired final by-product slag composition.

The source of calcium, in any of its forms (such as calcium, calcium oxide, or calcium carbonate), can be added to the molten silicon in a variety of ways. For example, in one embodiment, calcium carbonate may be added directly to the batch of molten silicon. In another embodiment, calcium oxide may be added serially such that a first charge of calcium oxide mixes with the molten aluminum-containing silicon before a second charge of calcium oxide is added. In yet another embodiment, calcium oxide can even be added to the aluminum-containing silicon before heating it in step 100. The source of calcium may otherwise be added in any alternative way, alone or in combination with other calcium sources or optionally with silica, such that the calcium substantially disperses as a dissolved element in the molten silicon during heating step 100.

After the source of calcium and, optionally silica, are added in step 300, the molten silicon is exposed to oxygen in step 400.

The combined effect of adding a source of calcium to the molten aluminum-containing silicon and exposing it to oxygen results in the production of refined silicon having lower aluminum content and a by-product slag. The by-product slag comprises calcium oxide, aluminum oxide, and silica, while the refined silicon comprises silicon and an amount of aluminum which is less than the initial amount of aluminum in the original aluminum-containing silicon material. In addition, the refined silicon will also comprise an amount of boron that is less than an initial amount of boron in the original aluminum-containing silicon material. Specifically, aluminum and other impurities (such as boron) that were initially present in the aluminum-containing silicon are at least partially removed via the production of the by-product slag wherein the amount of each component present in the by-product slag (e.g., calcium oxide, aluminum oxide, and silica) is a result of the aluminum and other impurities removed from the molten silicon batch. It should be noted, for good mixing to occur between the by-product slag and the refined silicon, that desirably the melting point of the by-product slag should be below that of the silicon. Furthermore, the density, viscosity, and melting point of the by-product slag permits one to predict the degree of refining (i.e. the amount of aluminum removed) of the molten silicon in the production process.

Exposing the molten aluminum-containing silicon to oxygen comprises adding oxygen to the molten silicon using any available method and in any amount which operates to oxidize the aluminum and calcium in the molten silicon into a by-product slag such that refined silicon is produced as discussed above. For example, where the ladle housing the molten silicon contains a porous plug, oxygen can be introduced via the porous plug. In one embodiment, oxygen can be added as a gaseous mixture that comprises oxygen and nitrogen. For example, in such an embodiment the gaseous mixture comprises a mixture of from about 50 to about 95% oxygen and from about 5 to about 50% nitrogen, or from about 60 to about 90% oxygen and from about 10 to about 40% nitrogen, or about 80% oxygen and about 20% nitrogen (all percentages by weight).

In addition, the gas flow rate of the oxygen may be varied depending on the overall amount of molten silicon as well as the specific composition of the molten silicon. For example, in one exemplary method, the gas flow rate for 320 kg of molten aluminum-containing silicon is about 5-14 Nm³/h. The molten silicon is exposed to oxygen for a time sufficient to produce by-product slag and refined silicon. Typically, such exposure will be, for example, from about 10 minutes to about 120 minutes, from about 30 minutes to about 60 minutes, or for about 45 minutes.

Once the molten silicon material containing the source of calcium is exposed to oxygen in step 400 such that by-product slag and refined silicon are produced, the by-product slag is separated from the refined silicon at step 500. The by-product slag comprises a higher density phase than that of the refined silicon phase so that as the refined silicon is poured from the ladle, the higher density by-product slag remains behind. In another embodiment, the refined silicon may be passed through a screen or filter to separate it from the by-product slag.

Depending in part on the initial amount of aluminum present in the original aluminum-containing silicon, refining method 10 can be repeated to achieve further removal of aluminum from the refined silicon. For example, in step 600, the initial amount of aluminum present in the original aluminum-containing silicon can be determined and compared with a predetermined threshold value. The threshold value can be chosen such that if the remaining amount of aluminum in the refined silicon batch is above that threshold value, refining method 10 is repeated as illustrated in step 610. However, if the remaining amount of aluminum in the refined silicon batch is equal to or less than the chosen threshold value (as illustrated in step 620), no further purification is necessary, and the refined silicon in step 700 can be used, for example, for solar applications. In one exemplary embodiment, the threshold value for the remaining aluminum content in the refined silicon may be chosen to be in the range of from about 10 ppmw to about 100 ppmw, from about 20 ppmw to about 75 ppmw, or about 50 ppmw.

It should be appreciated that by adding a source of calcium and, optionally silica, along with oxygen or an oxygen-containing gas to the aluminum-containing silicon, refined silicon can be produced having less than about 50 ppmw aluminum and only trace amounts of other impurities. The following examples demonstrate the measured effect of adding calcium carbonate and oxygen to an aluminum-containing silicon material for the removal of aluminum. Comparative Example 1 demonstrates that when aluminum-containing silicon is refined with a mixture of oxygen and nitrogen without adding a source of calcium, the aluminum content of the silicon is not appreciably lowered (i.e., little or no aluminum is removed from the silicon). Examples 2 and 3 demonstrate that when aluminum-containing silicon is refined with oxygen and a source of calcium (e.g., calcium carbonate), refined silicon is produced having an amount of aluminum that is less than the initial amount of aluminum in the original aluminum-containing silicon material.

### Comparative Example 1

In this comparative example, aluminum-containing silicon was refined without the addition of calcium. To start, 310 kg of aluminum-containing silicon was melted and poured into a metallurgical ladle. The initial amount of aluminum in the silicon (i.e., the amount of aluminum before refining) was measured to be 1054 ppmw. A gaseous mixture comprising 70 wt % oxygen and 30 wt % nitrogen was introduced into the metallurgical ladle via a plug installed proximate the bottom of the ladle. The gaseous mixture was injected for about 65 minutes at a flow rate of approximately 14 Nm³. After refining and separation from the by-product slag, the amount of aluminum remaining in the refined silicon was be measured to be 1040 ppmw. The temperature of the molten silicon before refining was 1559° C., while the temperature of the molten silicon after exposure to the oxygen containing gas was 1409° C.

### Example 2

As in the first Example, aluminum-containing silicon was used as the starting material. Calcium carbonate was added to the molten silicon prior to the introduction of oxygen. To start, 288 kg of aluminum-containing silicon was melted and poured into a metallurgical ladle. The initial amount of aluminum in the aluminum-containing silicon was measured to be 1920 ppmw. Seven (7) kg of precipitated calcium carbonate was then added to the molten silicon material. A gaseous mixture comprising 80 wt % oxygen and 20 wt % nitrogen was introduced into the metallurgical ladle via a plug installed proximate the bottom of the ladle. The gaseous mixture was injected for about 45 minutes at a flow rate of approximately 14 Nm³. After refining and separation of the by-product slag, the amount of aluminum remaining in the refined silicon was measured to be 44 ppmw, for a reduction in aluminum of 1876 ppmw. The temperature of the molten silicon before refining was 1544° C., while the temperature of the molten silicon after refining was 1410° C.

### Example 3

As in the first Example, aluminum-containing silicon was used as the starting material. Calcium carbonate was added to the molten aluminum-containing silicon prior to the introduction of oxygen. To start, 283 kg of aluminum-containing silicon was melted and poured into a metallurgical ladle. The initial amount of aluminum in the aluminum-containing silicon was measured to be 1275 ppmw. Seven (7) kg of precipitated calcium carbonate was then added to the molten silicon material. A gaseous mixture comprising 80 wt % oxygen and 20 wt % nitrogen was introduced into the metallurgical ladle via a plug installed proximate the bottom of the ladle. The gaseous mixture was injected for about 45 minutes at a flow rate of approximately 14 Nm³. After refining, the amount of aluminum remaining in the refined silicon was measured to be 18 ppmw, for a reduction of 1257 ppmw. The temperature of the molten silicon before refining was 1557° C., while the temperature of the molten silicon after refining was 1408° C.

It is noted that terms like “specifically,” “preferably,” “commonly,” and “typically” and the like, are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A method for refining aluminum-containing silicon comprising:
heating an initial aluminum-containing silicon material to form a molten aluminum-containing silicon;
adding a source of calcium selected from the group consisting of calcium, calcium oxide, and calcium carbonate to one of the initial aluminum-containing silicon material and the molten aluminum-containing silicon; and
after adding the source of calcium, exposing the molten aluminum-containing silicon to oxygen to produce a refined silicon and a by-product slag, said refined silicon containing an amount of aluminum less than the amount of aluminum in said aluminum-containing silicon.

2. A method as claimed in claim 1 including adding silica to said molten aluminum-containing silicon.

3. A method as claimed in claim 2 in which, for aluminum concentrations of from about 0.05 to about 0.3 wt. % in the initial aluminum-containing silicon material, from about 1.0 to about 10.0 wt. % silica based on the total weight of the initial aluminum-containing silicon material is added.

4. A method as claimed in claim 3 in which the ratio of the weight % silica to the weight % aluminum based on the total weight of the initial aluminum-containing silicon material ranges from about 20 to about 40.

5. A method as claimed in claim 1 wherein said source of calcium is added to the initial aluminum-containing silicon material prior to heating.

6. A method as claimed in claim 1, including adding silica to the initial aluminum-containing silicon material prior to heating.

7. A method as claimed in claim 1 wherein an initial amount of aluminum in said initial aluminum-containing silicon material comprises from about 1,000 up to about 12,000 ppmw.

8. A method as claimed in claim 1 wherein the amount of aluminum in said refined silicon is less than about 100 ppmw.

9. A method as claimed in claim 1 wherein the ratio of wt. % calcium added to the initial aluminum-containing silicon material or to the molten aluminum-containing silicon to the wt. % aluminum present in the initial aluminum-containing silicon material is from about 1 to about 10.

10. A method as claimed in claim 1 wherein said source of calcium comprises precipitated calcium carbonate.

11. A method as claimed in claim 1 wherein said oxygen is included in a gaseous mixture of oxygen and nitrogen.

12. A method as claimed in claim 11 wherein said mixture comprises from about 60 wt % to about 90 wt % oxygen and from about 10 wt % to about 40 wt % nitrogen such that a combined wt % of oxygen and nitrogen is 100 wt % or less.

13. A method as claimed in claim 1 wherein said molten aluminum-containing silicon is exposed to said oxygen for from about 10 minutes to about 120 minutes.

14. A method as claimed in claim 1 wherein said initial aluminum-containing silicon material comprises an initial amount of boron and said refined silicon comprises an amount of boron less than the initial amount of boron.

15. A method as claimed in claim 1 wherein said by-product slag comprises aluminum oxide, calcium oxide, and silica.

16. (canceled)
